(19) United States
(12) Patent Application Publication
(10) Pub. No.: US 2009/0259324 A1
(43) Pub. Date: Oct. 15, 2009

(54) BROADCAST DEVICES

(75) Inventor: Chih-Haw Won, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/101,258

(22) Filed: Apr. 11, 2008

(51) Int. Cl. G06F 17/00

(52) U.S. Cl. 700/94

(57) ABSTRACT

A broadcast device is disclosed, comprising a first memory unit, a demultiplexer unit, first and second flip-flop units, and first and second playback units. The demultiplexer unit generates an audio bit stream, which comprises a plurality of data packages, according to a transport stream. The demultiplexer unit writes the data packages into the first memory unit with a writing pointer. The first flip-flop unit reads and stores the data packages from the first memory unit. The first playback unit reads the data packages from the first flip-flop unit and decompresses the data packages for generating a first digital playback signal. The second flip-flop unit reads and stores the data packages from the first memory unit. The second playback unit reads the data packages from the second flip-flop unit and samples the data packages to generate a second digital playback signal to an external receiver outside of the broadcast device.

### BACKGROUND OF THE INVENTION

1. Field of the Invention

The invention relates to a broadcast device, and more particularly to a broadcast device with two flip-flop units for pulse code modulation (PCM) signals and non-PCM signals.

2. Description of the Related Art

In a digital broadcast application, there is only one audio output source for playing at one time point. For example, referring to a digital television, compressed audio data is decompressed and then transmitted to an internal digital-analog converter for playback, or compressed audio data is transmitted to an external receiver outside of the digital television and then played by the external receiver.

FIG. 1 shows a conventional broadcast device. Referring to FIG. 1, a broadcast device 1 comprises a demultiplexer 10, a controller 11, memory units 12-13, a flip-flop unit 14, a decompressor 15, sampling units 16 and 17, and a digital-analog converter (DAC) 18. The demultiplexer 10 receives a transport stream and generates an audio bit stream comprising a plurality of data packages. The demultiplexer 10 is controlled by the controller 11 to write the data packages into the memory unit 12. The flip-flop unit 14 reads the data packages from the memory unit 12 and stores the data packages. When users desire to play audio with a built-in speaker or record audio with a built-in recorder, the decompressor 15 reads the data packages from the flip-flop unit 14. The decompressor 15 decompresses the data packages to generate decompressed data packages for storing in the memory unit 13. The sampling unit 16 reads the decompressed data packages from the memory unit 13 and samples the decompressed data packages to generate the digital playback signal PB10. Then, the digital-analog converter 18 converts the digital playback signal PB10 to an analog playback signal for the built-in speaker or the built-in recorder. When users desire to play audio with an external speaker out side of the broadcast device 1, the sampling unit 17 reads the data packages from the flip-flop unit 14 and samples the data packages to generate a digital playback signal PB 11 for the external speaker.

Moreover, it is assumed that users desire to record audio with the built-in recorder (or play audio with the built-in speaker) and play audio with the external speaker at the same time. Both of the decompressor 15 and the sampling unit 17 reads the data packages from the flip-flop unit 14. The reading speed of the sampling unit 17 and the decompressing speed of the decompressor 15 are different. In general, the reading speed of the sampling unit 17 is less than the decompressing speed of the decompressor 15, thus, the operation of recording audio with the built-in recorder is restricted by the operating of playing audio with the external speaker. In order to eliminate this restriction, the flip-flop unit 14 has a large size, thus increasing the cost of the broadcast device 1.

### BRIEF SUMMARY OF THE INVENTION

An exemplary embodiment of a broadcast device comprises a first memory unit, a demultiplexer unit, first and second flip-flop units, and first and second playback units. The demultiplexer unit receives a transport stream and generates an audio bit stream according to the transport stream. The audio bit stream comprises a plurality of data packages, and the demultiplexer unit writes the data packages into the first memory unit in a predetermined order with a writing pointer. The first flip-flop unit reads the data packages with a first reading pointer from the first memory unit and stores the data packages. The first playback unit reads the data packages from the first flip-flop unit and decompresses the data packages for generating a first digital playback signal. The second flip-flop unit reads the data packages with a second reading pointer from the first memory unit and stores the data packages. The second playback unit reads the data packages from the second flip-flop unit and samples the data packages to generate a second digital playback signal to an external receiver outside of the broadcast device through an interface unit.

Another exemplary embodiment of a broadcast device comprises a first memory unit, a demultiplexer, a controller, a determination unit, first and second flip-flop units, and first and second playback units. The demultiplexer receives a transport stream and generates an audio bit stream according to the transport stream. The audio bit stream comprises a plurality of data packages. The controller controls the demultiplexer to write the data packages into the first memory unit in a predetermined order with a writing pointer. The first flip-flop unit reads the data packages with a first reading pointer from the first memory unit and stores the data packages. The second flip-flop unit reads the data packages with a second reading pointer from the first memory unit and stores the data packages. The determination unit determines which one among the first and second reading pointers is later to serve as a later reading pointer and transmits the later reading pointer to the controller. The controller then adjusts a writing speed of the demultiplexer to the first memory unit according to the writing pointer and the later reading pointer.

The first playback unit reads the data packages from the first flip-flop unit and decompresses the data packages for generating a first digital playback signal. The second playback unit reads the data packages from the second flip-flop unit and samples the data packages to generate a second digital playback signal to an external receiver outside of the broadcast device through an interface unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional broadcast device; and

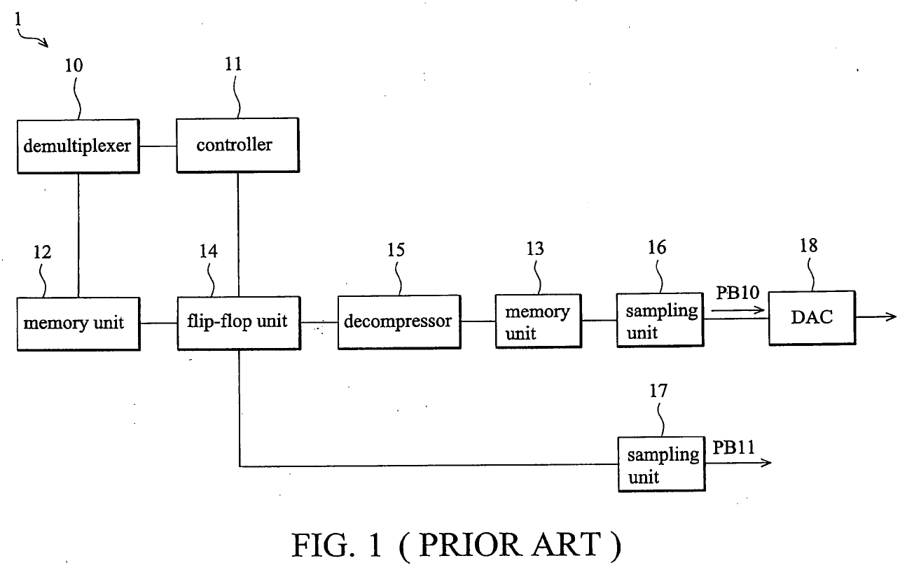

FIG. 2 shows an exemplary embodiment of a broadcast device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

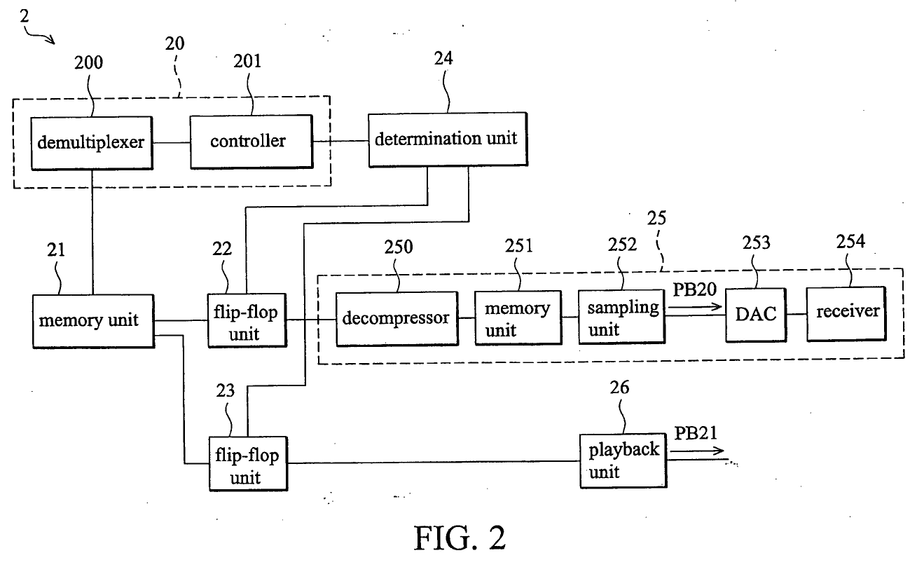

Broadcast devices are provided. In an exemplary embodiment of a broadcast device in FIG. 2, a broadcast device 2 comprises a demultiplexer unit 20, a memory unit 21, flip-flop units 22 and 23, a determination unit 24, and playback units 25 and 26. In the embodiment, the flip-flop units 22 and 23have small sizes. Referring to FIG. 2, the demultiplexer unit 20 comprises a demultiplexer 200 and a controller 201.

The demultiplexer 200 receives a transport stream and generates an audio bit stream according to the transport stream, and the audio bit stream comprises a plurality of data packages. The controller 201 is arranged to control the demultiplexer 200 to write the data packages into the memory unit 21 in a predetermined order with a writing pointer. The writing pointer indicates a writing position in the memory unit 21, whereby data packages are written into by the demultiplexer 200. The flip-flop unit 22 reads the data packages with a first reading pointer from the memory unit 21 and stores the data packages. The flip-flop unit 23 reads the data packages with a second reading pointer from the memory unit 21 and stores the data packages. The first reading pointer indicates a read position in the memory unit 21, whereby data packages are read from by the flip-flop unit 22. The second reading pointer indicates a read position in the memory unit 21, whereby data packages are read from by the flip-flop unit 23. The determination unit 24 obtains the first and second reading pointers in real-time. The determination unit 24 determines which one among the first and second reading pointers is later to serve as a later reading pointer and transmits the later reading pointer to the controller 201. Accordingly, the controller 201 adjusts a writing speed of the demultiplexer 200 to the memory unit 21 according to the writing pointer and the later reading pointer, so that in the predetermined order, the position in the memory unit 21 indicated by the writing pointer does not overtake a position in the memory unit 21 indicated by the later reading pointer. In other words, the position indicated by the writing pointer does not overtake both of the positions indicated by the first and second reading pointers in the predetermined order. In the embodiment, the controller 201 adjusts the writing speed according to the difference between positions in the memory unit 21 respectively indicated by the writing pointer and the later reading pointer.

Referring to FIG. 2, the playback unit 25 comprises a decompressor 250, a memory unit 251, a sampling unit 252, a digital-analog converter (DAC) 253, and an internal receiver 254. The decompressor 250 reads the data packages from the flip-flop unit 22 and decompresses the data packages to generate decompressed data packages. The memory unit 251 receives and stores the decompressed data packages. The sampling unit 252 reads the decompressed data packages from the memory unit 251 and samples the decompressed data packages to generate the digital playback signal PB20. The DAC 253 converts the digital playback signal PB 20 to an analog playback signal. The analog playback signal is transmitted to the receiver 254. In the embodiment, the receiver 254 can comprise a speaker module or a recorder module. When the receiver 254 comprises a speaker module, the analog playback signal referring to the audio bit stream is played by a built-in speaker in the speaker module. When the receiver 254 comprises a recorder module, the analog playback signal referring to the audio bit stream is recorded in a built-in recorder in the recorder module.

Moreover, the playback unit 26 reads the data packages from the flip-flop unit 23 and samples the data packages to generate a digital playback signal PB21. The digital playback signal PB21 is transmitted to an external receiver outside of the broadcast device 2 through an interface unit, such as Sony/Philips Digital InterFace (SPDIF). The external receiver can comprise an audio speaker module, and the digital playback signal PB21 is played by the speaker module. In the above embodiment, the digital playback signal PB21 is a pulse code modulation (PCM) signal, and the digital playback signal PB21 is a non-PCM signal.

According to the broadcast device 2 of the above embodiment, the operations of the playback units 25 and 26 are independent. When the analog playback signal is played (or recoded) by the internal receiver 254 and the digital playback signal PB21 is played by the external receiver simultaneously, one of the operations of the playback units 25 and 26 is not restricted by the other one.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A broadcast device, comprising
a first memory unit;
a demultiplexer unit receiving a transport stream and generating an audio bit stream according to the transport stream, wherein the audio bit stream comprises a plurality of data packages, and the demultiplexer unit writes the data packages into the first memory unit in a predetermined order with a writing pointer;
a first flip-flop unit reading the data packages with a first reading pointer from the first memory unit and storing the data packages;
a first playback unit reading the data packages from the first flip-flop unit and decompressing the data packages for generating a first digital playback signal;
a second flip-flop unit reading the data packages with a second reading pointer from the first memory unit and storing the data packages; and
a second playback unit reading the data packages from the second flip-flop unit and sampling the data packages to generate a second digital playback signal to an external receiver outside of the broadcast device through an interface unit.

2. The broadcast device as claimed in claim 1 further comprising:
a determination unit determining which one among the first and second reading pointers is later to serve as a later reading pointer and transmitting the later reading pointer to the demultiplexer unit, wherein the demultiplexer unit writes the data packages into the first memory unit in the predetermined order according to the writing pointer and the later reading pointer.

3. The broadcast device as claimed in claim 2, wherein the demultiplexer unit comprises:
a demultiplexer generating the audio bit stream according to the transport stream; and
a controller controlling the demultiplexer according to the writing pointer and the later reading pointer to write the data packages of the audio bit stream into the first memory unit.

4. The broadcast device as claimed in claim 3, wherein in the predetermined order, a position in the first memory unit indicated by the writing pointer does not overtake a position in the first memory unit indicated by the later reading pointer.

5. The broadcast device as claimed in claim 3, wherein the controller adjusts a writing speed of the demultiplexer to the first memory unit according to the difference between positions in the first memory unit respectively indicated by the writing pointer and the later reading pointer.

6. The broadcast device as claimed in claim 1, wherein the first playback unit comprises:
a decompressor reading the data packages from the first flip-flop unit and decompressing the data packages to generate decompressed data packages;
a second memory unit receiving and storing the decompressed data packages; and
a sampling unit reading the decompressed data packages from the second memory unit and sampling the decompressed data packages to generate the first digital playback signal.

7. The broadcast device as claimed in claim 6, wherein the first playback unit further comprises:
a digital-analog converter converting the first digital playback signal to an analog playback signal;
an internal receiver receiving the analog playback signal.

8. The broadcast device as claimed in claim 7, wherein the internal receiver comprises a speaker module or a recorder module.

9. The broadcast device as claimed in claim 1, wherein the external receiver comprises an audio speaker module.

10. The broadcast device as claimed in claim 1, wherein the interface unit comprises a Sony/Philips Digital InterFace (SPDIF).

11. The broadcast device as claimed in claim 1, wherein the first playback signal is a pulse code modulation (PCM) signal, and the second playback signal is a non-PCM signal.

12. A broadcast device, comprising
a first memory unit;
a demultiplexer receiving a transport stream and generating an audio bit stream according to the transport stream, wherein the audio bit stream comprises a plurality of data packages;
a controller controlling the demultiplexer to write the data packages into the first memory unit in a predetermined order with a writing pointer;
a first flip-flop unit reading the data packages with a first reading pointer from the first memory unit and storing the data packages;
a second flip-flop unit reading the data packages with a second reading pointer from the first memory unit and storing the data packages;
a determination unit determining which one among the first and second reading pointers is later to serve as a later reading pointer and transmitting the later reading pointer to the controller, wherein the controller adjusts a writing speed of the demultiplexer to the first memory unit according to the writing pointer and the later reading pointer;
a first playback unit reading the data packages from the first flip-flop unit and decompressing the data packages for generating a first digital playback signal; and
a second playback unit reading the data packages from the second flip-flop unit and sampling the data packages to generate a second digital playback signal to an external receiver outside of the broadcast device through an interface unit.

13. The broadcast device as claimed in claim 12, wherein in the predetermined order, a position in the first memory unit indicated by the writing pointer does not overtake a position in the first memory unit indicated by the later reading pointer.

14. The broadcast device as claimed in claim 12, wherein controller adjusts the writing speed of the demultiplexer according to the difference between positions in the first memory unit respectively indicated by the writing pointer and the later reading pointer.

15. The broadcast device as claimed in claim 12, wherein the first playback unit comprises:
a decompressor reading the data packages from the first flip-flop unit and decompressing the data packages to generate decompressed data packages;
a second memory unit receiving and storing the decompressed data packages; and
a sampling unit reading the decompressed data packages from the second memory unit and sampling the decompressed data packages to generate the first digital playback signal.

16. The broadcast device as claimed in claim 15, wherein the first playback unit further comprises:
a digital-analog converter converting the first digital playback signal to an analog playback signal;
an internal receiver receiving the analog playback signal.

17. The broadcast device as claimed in claim 16, wherein the internal receiver comprises a speaker module or a recorder module.

18. The broadcast device as claimed in claim 12, wherein the external receiver comprises an audio speaker module.

19. The broadcast device as claimed in claim 12, wherein the interface unit comprises a Sony/Philips Digital InterFace (SPDIF).

20. The broadcast device as claimed in claim 12, wherein the first playback signal is a pulse code modulation (PCM) signal, and the second playback signal is a non-PCM signal.
